(19) United States
(12) Patent Application Publication
(10) Pub. No.: US 2007/0257116 A1
(43) Pub. Date: Nov. 8, 2007

(54) Interface detection method of a multiple mode micro memory card

(76) Inventor: Hsiang-An Hsieh, Keelung City (TW)

Correspondence Address: NORTH AMERICA INTELLECTUAL PROPERTY CORPORATION, P.O. BOX 506, MERRIFIELD, VA, 22116, US

(21) Appl. No.: 11/381,740

(22) Filed: May 4, 2006

(51) Int. Cl. G06K 19/06

(52) U.S. Cl. 235/492

(57) ABSTRACT

A multiple mode micro memory card includes a housing having a first end and a second end; a memory for storing data; first and second sets of contact pads formed on the first end for sending and receiving data and control signals; and a controller electrically connected to the first and second sets of contact pads for receiving external signals through the first and second sets of contact pads, wherein the controller controls the multiple mode micro memory card to operate in a first mode when receiving external signals through only the first set of contact pads, controls the multiple mode micro memory card to operate in a second mode when receiving external signals through only the second set of contact pads, and controls the multiple mode micro memory card to operate in a third mode when receiving external signals through both the first and second sets of contact pads.

### BACKGROUND OF THE INVENTION

1. Field of the Invention

The present invention relates to a micro memory card, and more particularly, to a micro memory card capable of operating in multiple modes.

2. Description of the Prior Art

As personal electronic devices become smaller and more sophisticated, the need for small sized memory cards becomes greater. As a result, micro sized flash memory cards have entered the market, and are used for miniature electronic devices that require swappable memory cards.

Please refer to FIGS. 1 and 2. FIG. 1 is a front view of a MMCmicro™ memory card 10 according to the prior art. FIG. 2 is a front view of a microSD™ memory card 20 according to the prior art. Both the MMCmicro memory card 10 and the microSD memory card 20 are considered to be micro-sized flash memory cards. Unfortunately, the MMCmicro memory card 10 must be read through a MMCmicro socket, and cannot be read by a microSD socket. The same problem exists for the microSD memory card 20, which cannot be ready by a MMCmicro socket.

Therefore, although the MMCmicro memory card 10 and the microSD memory card 20 have a similar size, their incompatibility causes problems for users, who must ensure that memory cards and sockets match each other.

### SUMMARY OF THE INVENTION

It is therefore an objective of the claimed invention to provide a multiple mode micro memory card being compatible with both MMCmicro sockets and microSD sockets and a method of detecting the interface that the multiple mode micro memory card should use for sending and receiving data and control signals in order to solve the above-mentioned problems.

According to an exemplary embodiment of the claimed invention, a multiple mode micro memory card is disclosed. The multiple mode micro memory card includes a housing having a first end and a second end; a memory disposed in the housing for storing data; a first set of contact pads formed on the first end for sending and receiving data and control signals; a second set of contact pads formed on the second end for sending and receiving data and control signals; and a controller electrically connected to the first and second sets of contact pads for receiving external signals through the first and second sets of contact pads, wherein the controller controls the multiple mode micro memory card to operate in a first mode when receiving external signals through only the first set of contact pads, controls the multiple mode micro memory card to operate in a second mode when receiving external signals through only the second set of contact pads, and controls the multiple mode micro memory card to operate in a third mode when receiving external signals through both the first and second sets of contact pads.

According to another exemplary embodiment of the claimed invention, a method of detecting switching between modes of a multiple mode micro memory card is disclosed. The method includes providing the multiple mode micro memory card with first and second sets of contact pads respectively formed on first and second ends of the multiple mode micro memory card for sending and receiving data and control signals to a memory of the multiple mode micro memory card; controlling the multiple mode micro memory card to operate in a first mode when receiving external signals through only the first set of contact pads; controlling the multiple mode micro memory card to operate in a second mode when receiving external signals through only the second set of contact pads; and controlling the multiple mode micro memory card to operate in a third mode when receiving external signals through both the first and second sets of contact pads.

It is an advantage that the claimed multiple mode micro memory card can automatically detect the mode that it should operate in according to the received signals. In this way, the micro memory card can be utilized in three different types of sockets including a socket conforming to the first device connection standard, a socket conforming to the second device connection standard, and a socket that can receive a memory card conforming to both of the first and second connection standards.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a front view of a MMCmicro™ memory card according to the prior art.

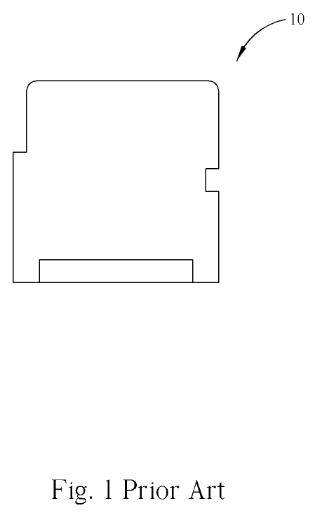

FIG. 2 is a front view of a microSD™ memory card according to the prior art.

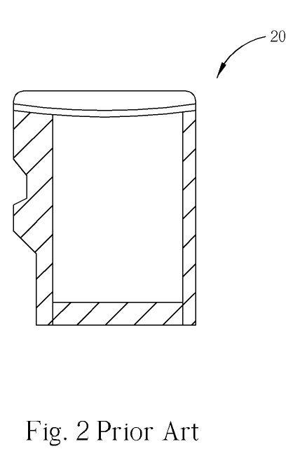

FIG. 3 is a front view of a multiple mode micro memory card according to the present invention.

FIG. 4 is a perspective front view of the multiple mode micro memory card.

FIG. 5 is a perspective rear view of the multiple mode micro memory card.

FIG. 6 is a rear view of the multiple mode micro memory card showing pad numbers for the first set of contact pads and the second set of contact pads.

FIG. 7 is a table describing the functions of contact pads on the multiple mode micro memory card when the multiple mode micro memory card is operated in different modes.

FIG. 8 is a functional block diagram of the multiple mode micro memory card according to the present invention.

FIG. 9 is a flowchart illustrating detecting which interface to use with the multiple mode micro memory card according to the present invention.

### DETAILED DESCRIPTION

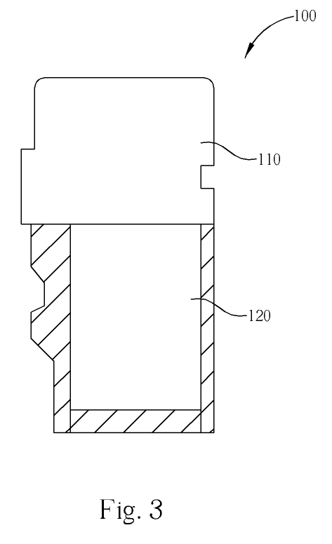

Please refer to FIG. 3. FIG. 3 is a front view of a multiple mode micro memory card 100 according to the present invention. The multiple mode micro memory card 100 contains a first housing 110 integrally joined with a second housing 120 to form an integrated housing. The first housing 110 is formed at a first end of the multiple mode micro memory card 100 and conforms to the MMCmicro memory card standard, whereas the second housing 120 is formed at a second end of the multiple mode micro memory card 100 and conforms to the microSD memory card standard. In addition, the multiple mode micro memory card 100 creates a new memory card standard that utilizes both the first housing 110 and the second housing 120 for reading and writing data. As a result, the multiple mode micro memory card 100 is compatible with three different micro memory card form factors: the MMCmicro memory card standard, the microSD memory card standard, and the form factor of the new multiple mode micro memory card 100.

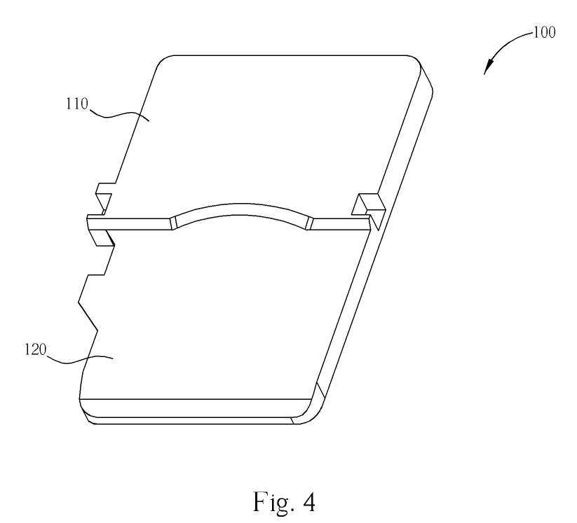

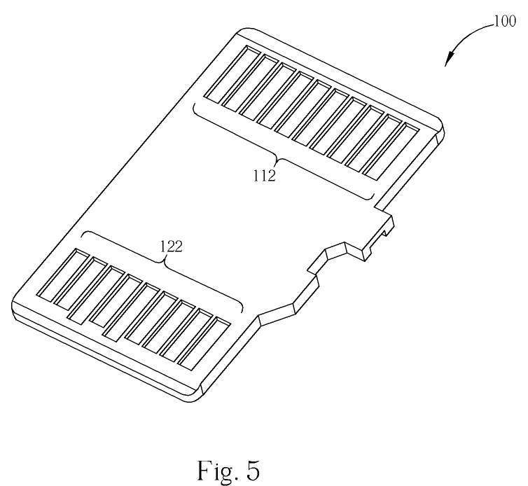

Please refer to FIGS. 4 and 5. FIG. 4 is a perspective front view of the multiple mode micro memory card 100. As shown, the first housing 110 has a greater thickness and a larger width than that of the second housing 120. This is due to the different dimensions of the MMCmicro memory card and microSD memory card form factors. FIG. 5 is a perspective rear view of the multiple mode micro memory card 100. The first housing 110 contains a set of ten first contact pads 112 and the second housing 120 contains a set of eight second contact pads 122, in accordance with both the MMCmicro memory card standard and the microSD memory card standard.

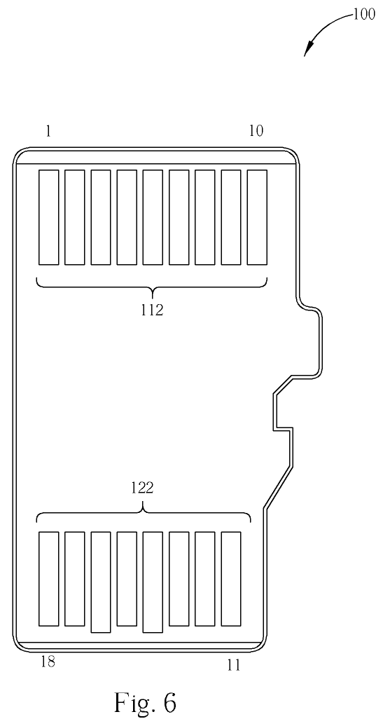

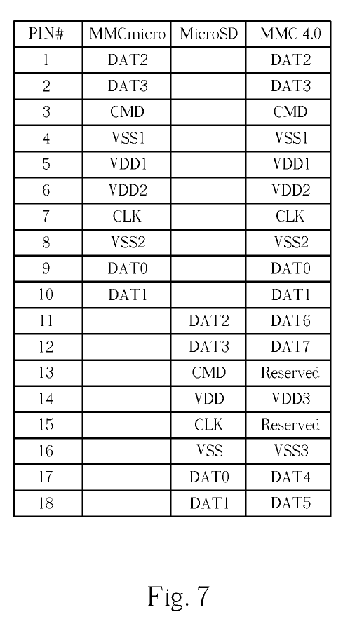

Please refer to FIG. 6 and FIG. 7. FIG. 6 is a rear view of the multiple mode micro memory card 100 showing pad numbers for the first set of contact pads 112 and the second set of contact pads 122. The first set of contact pads 112 are numbered from 1-10 and the second set of contact pads 122 are numbered from 11-18. FIG. 7 is a table describing the functions of contact pads on the multiple mode micro memory card 100 when the multiple mode micro memory card 100 is operated in different modes. When the multiple mode micro memory card 100 is operated according to either the MMCmicro memory card standard or the microSD memory card, a total of four data contact pads (DAT0-DAT3) are used for reading and writing data. However, when both the first set of contact pads 112 and the second set of contact pads 122 are used, the multiple mode micro memory card 100 is able to conform to the MMC 4.0 standard, and utilizes 8 data contact pads (DAT0-DAT7). Therefore, the multiple mode micro memory card 100 provides the ability to have twice the data throughput if both the first set of contact pads 112 and the second set of contact pads 122 are used for reading or writing data.

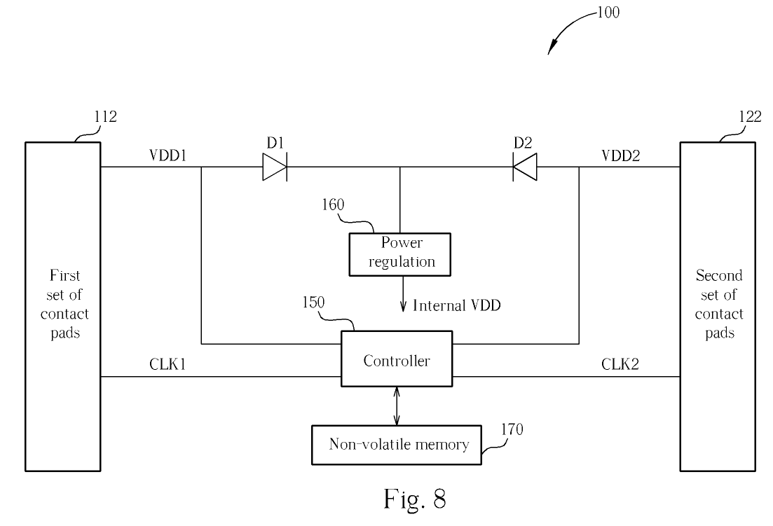

Please refer to FIG. 8. FIG. 8 is a functional block diagram of the multiple mode micro memory card 100 according to the present invention. When the multiple mode micro memory card 100 is placed into a socket connector of a host, the multiple mode micro memory card 100 will receive signals through the first set of contact pads 112, the second set of contact pads 122, or both the first set of contact pads 112 and the second set of contact pads 122. If no signals are received at all through either the first set of contact pads 112 or the second set of contact pads 122, then the multiple mode micro memory card 100 most likely does not fit in the socket connector of the host. As shown in FIG. 8, the signals received through the first set of contact pads 112 and the second set of contact pads 122 are voltage signals VDD1 and VDD2, respectively. In addition, clock signals CLK1 and CLK2 are also received for controlling the rate at which data and control signals are sent.

The voltage signals VDD1 and VDD2 and the clock signals CLK1 and CLK2 are each received by a controller 150, which controls the operation mode of the multiple mode micro memory card 100 and accesses a non-volatile memory 170 of the multiple mode micro memory card 100. Furthermore, a power regulation circuit 160 receives the voltage signal VDD1 through a diode D1 and also receives the voltage signal VDD2 through a diode D2 for generating an internal VDD voltage of the multiple mode micro memory card 100.

If the multiple mode micro memory card 100 only receives the voltage signal VDD1 through the first set of contact pads 112 and does not receive any voltage signal through the second set of contact pads 122, the multiple mode micro memory card 100 is operated in MMCmicro mode using the pad assignment shown in column 2 of FIG. 7. On the other hand, if the multiple mode micro memory card 100 only receives the voltage signal VDD2 through the second set of contact pads 122 and does not receive any voltage signal through the first set of contact pads 112, the multiple mode micro memory card 100 is operated in microSD mode using the pad assignment shown in column 3 of FIG. 7. Finally, if the multiple mode micro memory card 100 receives the voltage signal VDD1 through the first set of contact pads 112 while also receiving the voltage signal VDD2 through the second set of contact pads 122, the multiple mode micro memory card 100 is operated in MMC 4.0 mode using the pad assignment shown in column 4 of FIG. 7. As mentioned above, since all of the contact pads of the first set of contact pads 112 and the second set of contact pads 122 are used in MMC 4.0 mode, the data throughput is twice that of either the MMCmicro mode or the microSD mode since 8 data contact pads are used instead of 4.

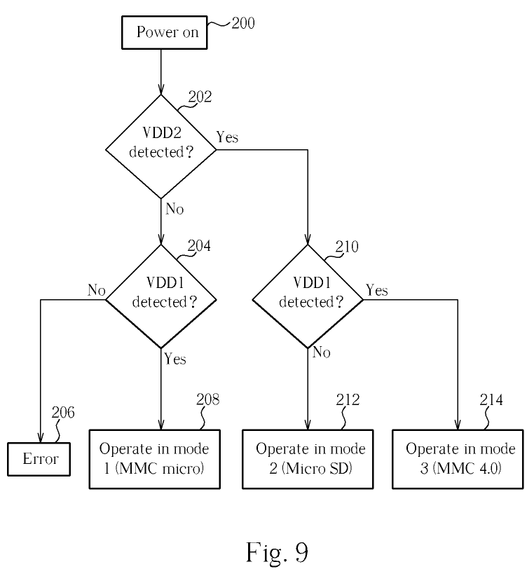

Please refer to FIG. 9. FIG. 9 is a flowchart illustrating detecting which interface to use with the multiple mode micro memory card 100 according to the present invention. Steps contained in the flowchart will be explained below.

Step 200: Power is supplied to the multiple mode micro memory card 100 through a host after the multiple mode micro memory card 100 is placed in a socket connector of the host.

Step 202: Determine if voltage VDD2 is detected through the second set of contact pads 122. If so, go to step 210. If not, go to step 204.

Step 204: Determine if voltage VDD1 is detected through the first set of contact pads 112. If so, go to step 208. If not, go to step 206.

Step 206: Since no voltage was detected through either the first set of contact pads 112 or the second set of contact pads 122, the multiple mode micro memory card 100 cannot be used in the host in this orientation. The multiple mode micro memory card 100 most likely does not fit in the socket connector of the host, or needs to be reversed to make proper contact with the socket connector of the host.

Step 208: The multiple mode micro memory card 100 operates in MMCmicro mode using the first set of contact pads 112.

Step 210: Determine if voltage VDD1 is detected through the first set of contact pads 112. If so, go to step 214. If not, go to step 212.

Step 212: The multiple mode micro memory card 100 operates in microSD mode using the second set of contact pads 122.

Step 214: The multiple mode micro memory card 100 operates in MMC 4.0 mode using both the first set of contact pads 112 and the second set of contact pads 122.

In summary, the present invention multiple mode micro memory card 100 is compatible with both the MMCmicro memory card standard and the microSD memory card standard. In addition, the multiple mode micro memory card 100 can also be utilized in a new mode utilizing all 18 pins of the first set of contact pads 112 and the second set of contact pads 122 for doubling the data transfer rate by using 8 data pins instead of 4. The present invention provides a way for the multiple mode micro memory card 100 to quickly detect what operation mode it should use for interfacing with the socket connector of the host. Depending on the signals received through the first set of contact pads 112 and the second set of contact pads 122, the appropriate operation mode is chosen.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A multiple mode micro memory card, comprising:
a housing having a first end and a second end;
a memory disposed in the housing for storing data;
a first set of contact pads formed on the first end for sending and receiving data and control signals;
a second set of contact pads formed on the second end for sending and receiving data and control signals; and
a controller electrically connected to the first and second sets of contact pads for receiving external signals through the first and second sets of contact pads, wherein the controller controls the multiple mode micro memory card to operate in a first mode when receiving external signals through only the first set of contact pads, controls the multiple mode micro memory card to operate in a second mode when receiving external signals through only the second set of contact pads, and controls the multiple mode micro memory card to operate in a third mode when receiving external signals through both the first and second sets of contact pads.

2. The card of claim 1, wherein the controller detects first and second voltage signals through the first and second sets of contact pads for determining the operation mode of the multiple mode micro memory card.

3. The card of claim 1, wherein the first end of the housing comprises a first device connector conforming to a first device connection standard and allowing access to the memory by a device compatible with the first device connection standard, and the second end of the housing comprises a second device connector conforming to a second device connection standard and allowing access to the memory by a device compatible with the second device connection standard, wherein the first set of contact pads is disposed on the first device connector and the second set of contact pads is disposed on the second device connector.

4. The card of claim 3, wherein the first set of contact pads comprises eight contact pads.

5. The card of claim 4, wherein the first device connection standard is a MMCmicro standard.

6. The card of claim 3, wherein the second set of contact pads comprises ten contact pads.

7. The card of claim 6, wherein the second device connection standard is a microSD standard.

8. The card of claim 3, wherein the first set of contact pads comprises eight contact pads and the second set of contact pads comprises ten contact pads.

9. The card of claim 8, wherein the first device connection standard is a MMCmicro standard and the second device connection standard is a microSD standard.

10. The card of claim 1, wherein when operating in the first mode, the controller controls the first set of contact pads to operate according to a MMCmicro standard, when operating in the second mode, the controller controls the second set of contact pads to operate according to a microSD standard, and when operating in the third mode, the controller controls the first and second sets of contact pads to operate according to a MMC 4.0 standard.

11. A method of detecting switching between modes of a multiple mode micro memory card, the method comprising:
providing the multiple mode micro memory card with first and second sets of contact pads respectively formed on first and second ends of the multiple mode micro memory card for sending and receiving data and control signals to a memory of the multiple mode micro memory card;
controlling the multiple mode micro memory card to operate in a first mode when receiving external signals through only the first set of contact pads;
controlling the multiple mode micro memory card to operate in a second mode when receiving external signals through only the second set of contact pads; and
controlling the multiple mode micro memory card to operate in a third mode when receiving external signals through both the first and second sets of contact pads.

12. The method of claim 11, further comprising detecting first and second voltage signals through the first and second sets of contact pads for determining the operation mode of the multiple mode micro memory card.

13. The method of claim 11, wherein the first end of the multiple mode micro memory card comprises a first device connector conforming to a first device connection standard and allowing access to the memory by a device compatible with the first device connection standard, and the second end of the multiple mode micro memory card comprises a second device connector conforming to a second device connection standard and allowing access to the memory by a device compatible with the second device connection standard, wherein the first set of contact pads is disposed on the first device connector and the second set of contact pads is disposed on the second device connector.

14. The method of claim 13, wherein the first set of contact pads comprises eight contact pads.

15. The method of claim 14, wherein the first device connection standard is a MMCmicro standard.

16. The method of claim 13, wherein the second set of contact pads comprises ten contact pads.

17. The method of claim 16, wherein the second device connection standard is a microSD standard.

18. The method of claim 13, wherein the first set of contact pads comprises eight contact pads and the second set of contact pads comprises ten contact pads.

19. The method of claim 18, wherein the first device connection standard is a MMCmicro standard and the second device connection standard is a microSD standard.

20. The method of claim 11, wherein when operating in the first mode, the first set of contact pads are controlled to operate according to a MMCmicro standard, when operating in the second mode, the second set of contact pads are controlled to operate according to a microSD standard, and when operating in the third mode, the first and second sets of contact pads are controlled to operate according to a MMC 4.0 standard.
